(19) United States
(12) Patent Application Publication
(10) Pub. No.: US 2004/0087403 A1
(43) Pub. Date: May 6, 2004

(54) Manual input device

(75) Inventor: Takuya Maeda, Miyagi-ken (JP)

Correspondence Address: Brinks Hofer Gilson & Lione, P. O. Box 10395, Chicago, IL, 60610, US

(73) Assignee: Alps Electric Co., Ltd.

(21) Appl. No.: 10/691,335

(22) Filed: Oct. 22, 2003

(30) Foreign Application Priority Data
Oct. 30, 2002 (JP) 2002-316229

(51) Int. Cl. F16H 3/72

(52) U.S. Cl. 475/2

(57) ABSTRACT

A manual input device contains a rotatable operating member, a motor that exerts a rotational force on the operating member, a planet gear mechanism having a sun gear fixed to an output shaft of the motor, planet gears engaging and moving around the sun gear, a ring gear engaging the planet gears on the inner peripheral side thereof, a carrier rotatably supporting the planet gears and rotating along with the planet gears, and a carrier shaft rotating integrally with the carrier and the operating member. A motor holder has at least one projection which abuts against at least one side surface of an end portion of the motor, is disposed on a side of the motor holder opposite from an output shaft side of the motor holder, and is configured to hold the motor.

### BACKGROUND OF THE INVENTION

1. Field of the Invention

The present invention relates to a manual input device provided in various electric equipment each having an operating member to be rotated manually for exerting a predetermined rotational force to the operating member dependent on the direction of rotation and the amount of rotation of the operating member.

2. Description of the Related Art In the related art, there is a manual input device mounted on electric equipment for supplying signals to the electric equipment by rotating an operating member.

A manual input device previously introduced by the present applicant contains a rotating operating member, a motor for exerting a rotational force to the operating member, and a planet gear mechanism interposed between the operating member and the motor.

The planet gear mechanism includes a sun gear to which the rotational force is supplied from the output shaft of the motor, a plurality of planet gears engaging the sun gear and moving around the sun gear, a ring gear engaging these planet gears on the inner peripheral side thereof, a carrier for rotatably supporting the plurality of planet gears and rotating along with the movement of the planet gears around the sun gear, and a carrier shaft rotating integrally with the carrier and the operating member.

Adjusting means is provided for adjusting engagement between the sun gear and the planet gears. The adjusting means includes the sun gear formed into a drum shape, and supporting means for pivotably supporting the sun gear.

The supporting means includes a first revolving body fixed to the output shaft of the motor, and a second revolving body being formed integrally with the sun gear and engaged with the first revolving body so as to rotate integrally therewith. The supporting means also includes engaging means for engaging the first revolving body and the second revolving body so that the second revolving body is pivotably supported by the first revolving body and that the first revolving body and the second revolving body rotates integrally with each other.

According to the manual input device constructed as described above, when assembling the motor and the planet gear mechanism, engagement between the sun gear and the planet gears can be adjusted by pivoting the sun gear with respect to the planet gear by pivoting the second revolving body with respect to the first revolving body fixed to the output shaft of the motor.

In the above described manual input device, it is necessary to form the sun gear into a drum shape, and it is also necessary to provide a plurality of projections and notches on the first revolving body and the second revolving body as engaging means for engaging the first revolving body fixed to the output shaft of the motor and the second revolving body which is integral with the sun gear. In other words, in the manual input device described above, the number of parts having complex configurations increases in comparison with the case in which the sun gear is fixed to the output shaft of the motor to engage the sun gear and the planet gears, and thus the cost for manufacturing the manual input device increases.

### SUMMARY OF THE INVENTION

One advantage of the present invention is engagement between the sun gear and the planet gears in a manual input device can be adjusted by a part having a simple configuration.

One embodiment the present invention includes a manually rotatable operating member. A motor exerts a rotational force to the operating member. A planet gear mechanism has a sun gear fixed to the output shaft of the motor, a plurality of planet gears engagable with and movable around the sun gear, a ring gear engagable with the planet gears on an inner peripheral side thereof, a carrier that rotatably supports the plurality of planet gears and rotates along with the movement of the planet gears around the sun gear, and a carrier shaft that rotates integrally with the carrier and the operating member. A detector detects at least one of the direction of rotation and the amount of rotation of the output shaft of the motor. A controller controls the motor such that a predetermined rotational force is exerted on the operating member dependent on the at least one of the direction of rotation and the amount of rotation of the output shaft detected by the detector. A motor holder has at least one projection which abuts against at least one side surface of an end portion of the motor. The at least one projection is disposed on a first the side opposite from an output shaft side of the motor holder. The at least one projection is configured to hold the motor.

In another embodiment, the manual input device comprises a rotatable operating member; a motor having an output shaft and that exerts a rotational force on the operating member; a planet gear mechanism having a sun gear fixed to the output shaft of the motor, a plurality of planet gears engaging and moving around the sun gear, a ring gear engaging the planet gears on the inner peripheral side thereof, a carrier that rotatably supports the planet gears and rotates along with movement of the planet gears around the sun gear, and a carrier shaft that rotates integrally with the carrier and the operating member; and a motor holder having at least one projection which abuts against at least one side surface of the motor and is configured to hold the motor such that the sun gear is pivotable with respect to the planet gear by pivoting the motor about the at least one projection of the motor holder.

In this embodiment, engagement between the sun gear and the planet gears may be adjustable solely through pivoting of the motor about the at least one projection of the motor holder.

According to the embodiments described above, since the sun gear can be pivoted with respect to the planet gear by pivoting the motor about the projection(s) of the motor holder when assembling the motor and the planet gear mechanism, engagement between the sun gear and the planet gears can be adjusted. In other words, engagement between the sun gear and the planet gears can be adjusted by a part having a simple configuration such as a motor holder having a plurality of projections.

It is also possible to provide one or more pairs of projections such that each of the pairs of projections is disposed at opposite locations with the intermediary of the centerline of the output shaft. In this arrangement, the motor can be stabily pivoted by 360°.

The motor holder may have a projection that abuts with the entire periphery of the side surfaces of the end portion of the motor on the side opposite from the output shaft instead of a plurality of projections. In this arrangement, the motor can also be stabily pivoted by 360°.

The motor holder may include a plurality of side plates disposed on the side of the motor in parallel with the output shaft, a first end plate opposing a first end surface of the motor on the side of the output shaft, and a second end plate opposing a second end surface of the motor on the side opposite from the output shaft. In this case, the side plates may be provided with the one or more projections. The first end plate is divided into a first end plate strip integrated with a first side plate of the side plates and a second end plate strip integrated with a second side plate of the side plates. The second end plate includes a first hinge unit that rotatably supports the first side plate such that the first end plate strip moves away from the second end plate strip. A second hinge unit rotatably supports the second side plate such that the second end plate strip moves away from the first end plate strip. Each end plate strip has a notch forming a hole through which the output shaft is arranged.

In the above embodiment, the first side plate and the first end plate strip may be opened and closed with respect to the second side plate and the second end pate strip by rotating each of the side plates about the first hinge unit and the second hinge unit respectively.

The motor may be pivotable by 360° about the at least one projection. The input device may also comprise a limiting member to which the carrier is attached and that limits movement of the planet gears in an axial direction. In this case, the carrier may have a disk portion and have connecting portions that extend along a periphery of the disk portion in the axial direction and that are connected to the limiting member, the connecting portions may have projections projecting in the axial direction and snap claws projecting in a direction orthogonal to the axial direction, and the limiting member may have a disk portion and may have connecting portions that extend along the periphery of the disk portion corresponding to the connecting portions of the carrier. In this case, the connecting portions of the limiting member have openings with which the snap claws engage and the disk potion of the limiting member includes holes to which the projections of the connecting portions are fitted.

The detector may comprise an encoder having a code plate formed integrally with the sun gear, a light emitting unit, and a light receiving unit opposing the light emitting unit with the intermediary of the code plate. In this case, the input device may further comprise: a circuit board fixed to an end surface of the motor with a bracket, the light emitting unit and the light receiving unit being connected to the circuit board, and a holder fixed to the circuit board and holding the light emitting unit and the light receiving unit.

The manual input device may further comprise an annular member to which the motor holder is snap-fitted, the motor holder contacting an internal surface of the annular member. In this case, snap claws provided on side plates of the motor holder engage with engaging holes formed on the annular member and the ring gear is formed in the annular member.

In another embodiment, a method of manufacturing a manual input device comprises: obtaining a rotatable operating member; connecting a motor with the operating member such that the motor exerts a rotational force on the operating member; attaching a sun gear to an output shaft of the motor; coupling a plurality of planet gears with the sun gear such that the planet gears engage and move around the sun gear; coupling a ring gear with the planet gears such that the planet gears engage an inner peripheral side of the ring gear; rotatably supporting the planet gears with a carrier that rotates along with movement of the planet gears around the sun gear; configuring a detector to detect at least one of a direction of rotation and an amount of rotation of the output shaft of the motor; configuring a controller to control the motor such that a predetermined rotational force is exerted on the operating member dependent on the at least one of the direction of rotation and the amount of rotation of the output shaft detected by the detector; and holding the motor using a motor holder having at least one projection that abuts against at least one side surface of an end portion of the motor, the at least one projection disposed on a first side of the motor holder opposite from an output shaft side of the motor holder, the at least one projection configured to hold the motor.

The method may further comprise providing at least one pair of projections such that each pair of projections are disposed at opposite locations with the intermediary of a centerline of the output shaft. While a plurality of pairs of projections may also be provided, only a single projection that abuts an entire periphery of the side surfaces of the end portion of the motor on the first side of the motor holder may be provided.

The motor holder may comprise a plurality of side plates disposed on a second side of the motor in parallel with the output shaft, a first end plate opposing a first end surface of the motor on a side of the output shaft, and a second end plate opposing a second end surface of the motor on aside opposite from the output shaft side, and the side plates are provided with the at least one projection, the first end plate contains a first end plate strip integrated with a first side plate of the side plates and a second end plate strip integrated with a second side plate of the side plates. In this case, the method may further comprise rotatably supporting the first side plate with a first hinge unit of the second end plate such that the first end plate strip is moveable away from the second end plate strip, rotatably supporting the second side plate with a second hinge unit such that the second end plate strip is moveable away from the first end plate strip, and arranging the output shaft through a notch in each of the first and second end plate strip.

The method may further comprise disposing the motor in the motor holder such that the motor is pivotable by 360° about the at least one projection.

The method may further comprise attaching a limiting member to the carrier thereby limiting movement of the planet gears in an axial direction. In this case, the carrier may have a disk portion and has connecting portions that extend along a periphery of the disk portion in the axial direction and that are connected to the limiting member with the connecting portions having projections projecting in the axial direction and snap claws projecting in a direction orthogonal to the axial direction, the limiting member may have a disk portion and have connecting portions that extend along the periphery of the disk portion corresponding to the connecting portions of the carrier, and the method may further comprise engaging the snap claws with openings of the connecting portions of the limiting member and fitting the projections of the connecting portions to holes in the disk potion of the limiting member.

The method may further comprise disposing a light emitting unit and a light receiving unit of the detector such that the light receiving unit opposes the light emitting unit with the intermediary of a code plate of an encoder, the code plate formed integrally with the sun gear. In this case, the method may further comprise fixing a circuit board to an end surface of the motor with a bracket, the light emitting unit and the light receiving unit connected to the circuit board, a holder fixed to the circuit board and holding the light emitting unit and the light receiving unit.

The method may further comprise snap-fitting an annular member to the motor holder such that the motor holder contacts an internal surface of an annular member, the annular member being snap-fitted through engagement of snap claws provided on side plates of the motor holder with engaging holes formed on the annular member, the ring gear being formed in the annular member.

### BRIEF DESCRIPTION OF THE DRAWINGS

FIG. 1 is an exploded perspective view of an embodiment of a manual input device according to the present invention;

FIG. 2 is a vertical cross-sectional view showing a planet gear mechanism provided in the manual input device according to the present invention; and

FIG. 3 is an explanatory drawing showing a state in which a motor held by a motor holder shown in FIG. 1 pivots.

### DESCRIPTION OF THE PREFERRED EMBODIMENTS

Referring now to the drawings, an embodiment of a manual input device according to the present invention will be described.

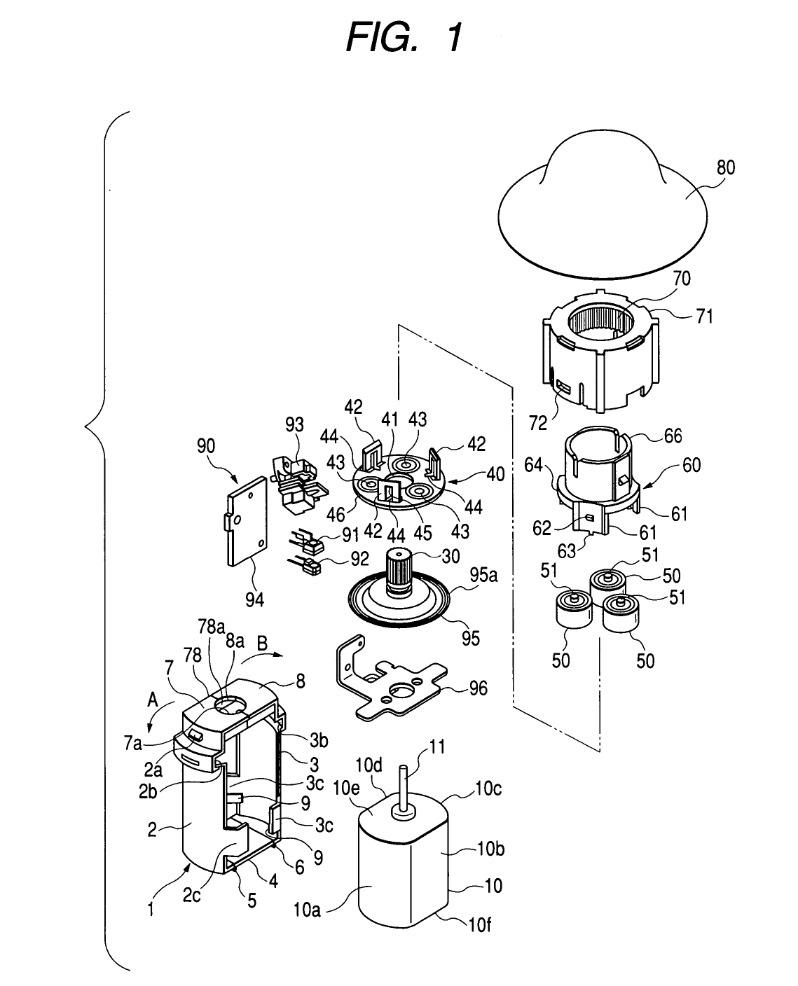

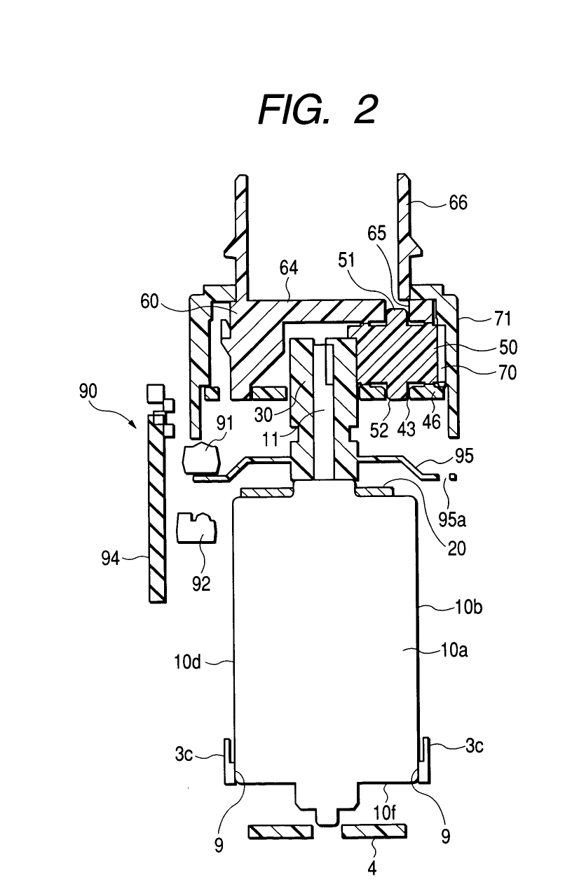

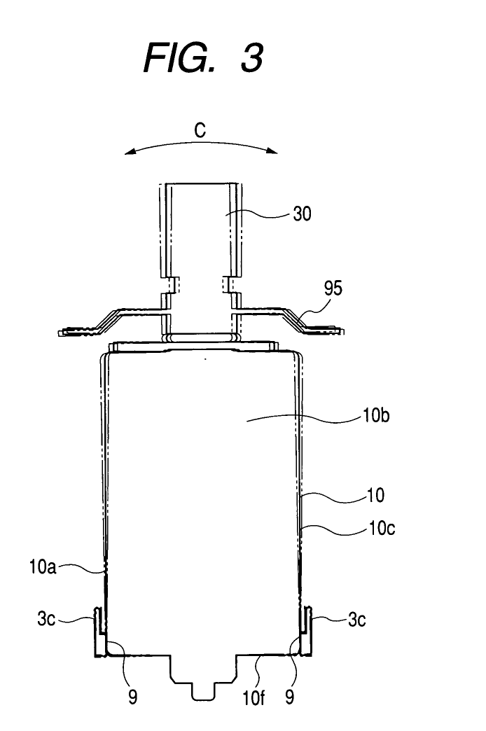

FIG. 1 is an exploded perspective view according to the embodiment, FIG. 2 is a vertical cross-sectional view showing a planet gear mechanism provided in the embodiment, and FIG. 3 is an explanatory drawing showing a state in which a motor held by a motor holder shown in FIG. 1 pivots.

The present embodiment includes an operating member 80 provided in electrical equipment, for example, on-vehicle electric equipment, and rotated manually as shown in FIG. 1 and FIG. 2. A motor exerts a rotational force on the operating member 80. The motor has an output shaft 11. A planet gear mechanism is interposed between the motor 10 and the operating member 80. A detector detects the direction of rotation and the amount of rotation of the output shaft 11 of the motor 10. The detector may include for example, an encoder 90. A controller, not shown, controls the motor 10 such that a predetermined rotational force is exerted on the operating member 80 according to the direction of rotation and the amount of rotation of the output shaft 11 detected by the encoder 90, and a motor holder 1 for holding the motor 10.

The planet gear mechanism may be constructed only of components formed of synthetic resin. As shown in FIG. 2, the planet gear mechanism includes a sun gear 30 that is fixed to the output shaft 11 of the motor 10, a plurality of planet gears 50 engaging the sun gear 30 and moving around the sun gear 30, a ring gear 70 engaging the planet gears 50 on the inner peripheral side thereof, a carrier 60 rotatably supporting the three planet gears 50 respectively and rotating along with the movement of the planet gears 50 around the sun gear, and a carrier shaft 66 rotating integrally with the carrier 60 and the operating member 80. In the embodiment shown, three planet gears 50 engage the sun gear 30, although a greater or fewer number of planet gears may exist.

Each of the planet gears 50 is, as shown in FIG. 2, integrally provided with revolving shafts 51, 52. The revolving shaft 51 is rotatably inserted into a shaft hole 65 formed on a disk portion 64 of the carrier 60. The revolving shaft 52 is rotatably inserted into a shaft hole 43 formed on a disk portion 46 of the limiting member 40 (shown in FIG. 1).

The carrier 60 is attached with the limiting member 40 and limits the movement of the planet gear 50 in the axial direction by snap-fit as shown in FIG. 1. The carrier 60 is provided with three connecting portions 61 to be connected to the limiting member 40 extending along the periphery of the disk portion 64 thereof. The connecting portions 61 extend in the axial direction, each being provided with a snap claw 62 projecting in the direction orthogonal to the axial direction and a projection 63 projecting in the axial direction. The limiting member 40 is provided with a plurality of connecting portions 42 extending along the periphery of the disk portion 46 corresponding to the connecting portions 61 of the carrier 60. The connecting portion 42 is formed into an inverted angular U shape extending in the axial direction, and the snap claw 62 engages the opening 45 thereof. The disk potion 46 of the limiting member 44 includes a hole 44 at the center of the proximal portion of each connecting portion 42, to which the projection 63 is fitted.

The encoder 90 includes, as shown in FIG. 1, a code plate 95 formed integrally with the sun gear 30, a light emitting unit 92 and a light receiving unit 91 opposed to each other with the intermediary of the code plate 95, a circuit board 94 which is fixed to an end surface 10e of the motor 10 with a bracket 96 formed of metal for example and to which the light emitting unit 92 and the light receiving unit 91 are connected, and a holder 93 fixed to the circuit board 94 and holding the light emitting unit 92 and the light receiving unit 91. Although not shown, detected signals output from the encoder 90 are supplied to the controller.

The controller controls the motor 10 such that a predetermined rotational force is exerted on the operating member 80. For example, a rotational force of a predetermined strength is exerted on the operating member 80 in a direction opposite from the direction of rotation of the operating member 80, according to detected signals from the encoder 90, that is, according to the direction of rotation and the amount of rotation of the output shaft 11.

The motor holder 1 includes, as shown in FIG. 1, a pair of side plates 2, 3 disposed on the side of the motor 10 in parallel with the output shaft 11, a first end plate 78 opposing the end surface 10e of the motor 10 on the side of the output shaft 11, and a second end plate 4 opposing the end surface 10f of the motor 10 on the side opposite from the output shaft 11. The pair of side plates 2, 3 are provided with recesses 2b, 3b respectively for avoiding contact with the code plate 95.

The first end plate 78 is divided into a first end plate strip 7 formed integrally with the side plate 2 and a second end plate strip 8 formed integrally with the side plate 3. The first end plate strip 7 and the second end plate strip 8 are formed with notches 7a, 8a respectively that form a hole 78a in which the sun gear 30 is rotatably arranged.

The second end plate 4 includes a first hinge unit 5 that rotatably supports the side plate 2 such that the end plate strip 7 is movable away from the second end plate strip 8, that is, in the direction indicated by an arrow A in FIG. 1, and a second hinge unit 6 that rotatably supports the side plate 3 such that the end plate strip 8 is movable away from the first end plate strip 7, that is, in the direction indicated by an arrow B in FIG. 1.

In other words, the motor holder 1 is constructed such that the side plate 2 and the first end plate strip 7 can be opened and closed with respect to the side plate 3 and the second end plate strip 8 by rotating the pair of side plates 2, 3 about the first hinge unit 5 and the second hinge unit 6, respectively.

The motor holder 1 is snap-fitted into the annular member 71 so as to contact the internal surface thereof with the first end plate strip 7 and the second end plate strip 8 abutted against each other. A snap claw 2a provided on the side plate 2 of the motor holder 1 engages an engaging hole 72 formed on the annular member 71, and a snap claw, not shown, provided on the side plate 3 in the same manner as the side plate 2 engages an engaging hole, not shown, formed on the annular member 71 in the same manner as the engaging hole 72. The annular member 71 is provided with the ring gear 70, whereby the ring gear 70 is fixed to the motor holder 1.

The pair of side plates 2, 3 are formed with the plurality of projections 9 that abut the side surfaces of the end portion of the motor 10 on the side opposite from the output shaft 11. For example, although four projections may be used the number of projections may be varied depending on design considerations. The projections 9 abut, for example, the corners formed by the side surfaces of the end portion of the motor 10. More specifically, the projections 9 may abut the corner formed by the side surfaces 10a, 10b on the side surfaces of the end portion of the motor 10 on the side opposite from the output shaft 11 and the periphery thereof, the corner formed by the side surfaces 10a, 10 d and the periphery thereof, the corner of the motor 10 formed by the side surfaces 10b, 10c and the periphery thereof, and the corner of the motor 10 formed by the side surfaces 10c, 10d and the periphery thereof. In other words, in such an embodiment the motor holder 1 is provided with two pairs of projections 9, each being disposed at two opposing locations with the intermediary of the centerline of the output shaft 11.

A pair of arm members 2c, of which only one is shown, are formed on both ends of the side plate 2 into shapes which embrace the side surfaces 10b, 10d of the motor 10. The projections 9 are formed from portions of the side plate 2 in the vicinity of the proximal portions of the respective arm members 2c along the arm members 2c. In the same manner, the side plate 3 is also provided with a pair of arm members 3c at both ends thereof formed into shapes which embrace the side surfaces 10b, 10d of the motor 10, and the projections 9 are formed from the portions of the side plates 3 in the vicinity of the proximal portions of the respective arm members 3c along the arm members 3c.

When the motor 10 is held by the motor holder 1, these four projections 9 provided on the motor holder 1 abut against the corner formed by the side surfaces 10a, 10b of the motor 10 and the periphery thereof, the corner formed by the side surfaces 10c, 10d and the periphery thereof, the corner formed by the side surface 10b and the side surface 10c and the periphery thereof, and the corner formed by the side surfaces 10d, 10a and the periphery thereof, respectively. Consequently, the motor 10 is pivotable by 360° about the projections 9.

For example, as shown in FIG. 3, the two projections 9 provided on the side plate 3 abut against the side surfaces 10a, 10c of the motor 10, respectively. The two projections 9 provided on the pair of arm members 2c of the side plate 2 also abut against the side surfaces 10a, 10c of the motor 10, respectively, in the same manner. Consequently, the motor 10 is pivotable in the direction indicated by an arrow C about the projection 9 abutted against the side surface 10a and the projection 9 abutted against the side surface 10c.

The present embodiment is operated as follows:

When the operating member 80 is rotated in one direction for example, the carrier shaft 66 and the carrier 60 rotates in that direction integrally with the operating member 80. Since the ring gear 70 is fixed to the motor holder 1, the planet gears 50 rotate in the opposite direction about the revolving shafts 51, 52 and move in the direction about the sun gear 30. Accordingly, the sun gear 30, the code plate 95, and the output shaft 11 rotate in the same direction. The sun gear 30, the code plate 95, and the output shaft 11 rotate at a rotating speed greater than the rotating speed of the operating member 80 dependent on the gear ratio between the sun gear 30 and the ring gear 70.

The direction of rotation and the amount of rotation of the operating member 80 are detected by the encoder 90. The detected signals corresponding to the direction and the amount of rotation are supplied to the controller, and the controller controls the motor 10. Accordingly, a rotational force of a predetermined strength, for example, in the opposite direction is output from the output shaft 11 of the motor 10.

The rotational force in the opposite direction output from the output shaft 11 is transmitted to the operating member 80 via the sun gear 30, the planet gears 50, the carrier 60, and the carrier shaft 66. In other words, the operating member 80 is supplied with a rotational force in the opposite direction to the operating direction. Then the operating member 80 is supplied with a rotational force output from the output shaft 11 that is increased dependent on the gear ratio between the sun gear 30 and the ring gear 70.

According to the present embodiment, the following effects are achieved:

According to the embodiment shown in FIG. 1, when assembling the motor 10 and the planet gear mechanism, the sun gear 30 fixed to the output shaft 11 of the motor 10 may be pivoted with respect to the planet gears 50 by pivoting the motor 10 held by the motor holder 1 about the projections 9 on the motor holder 1, so that engagement between the sun gear 30 and the planet gears 50 may be adjusted. In other words, according to this embodiment, engagement between the sun gear 30 and the planet gears 50 may be adjusted by a component having a simple configuration, notably a motor holder 1 having the projections 9. This reduces the manufacturing cost.

Although only one pair of projections may be provided to allow the motor 10 to pivot by 360°, with an increasing number of pairs of projections, the stability is enhanced. Thus, in the embodiment shown since two pairs of projections 9 are provided, each being disposed at two opposing locations with the intermediary of the centerline of the output shaft 11, the motor 10 can be stabily pivoted by 360° (or any portion thereof) . This also increases the accuracy of adjustment of engagement between the sun gear 30 and the planet gears 50.

In addition, the side plate 2 and the end plate strip 7 can be opened and closed with respect to the side plate 3 and the end plate strip 8 by rotating the pair of side plates 2, 3 about the first hinge unit 5 and the second hinge unit 6 respectively. This permits the motor 10 to be disposed easily in the motor holder 1.

As above, although the motor holder 1 includes two pair of projections 9, each being disposed at two opposing locations with the intermediary of the centerline of the output shaft 11, the present invention is not limited thereto. In other words, the motor holder 1 may have more than two pairs of projections and the projections may abut entirely against the periphery of the side surfaces at the end portion of the motor 10 on the side opposite from the output shaft 11. With the motor holder 1 in such construction, the motor 10 can be stabily pivoted by 360°.

As described above, when assembling the motor and the planet gear mechanism, engagement between the sun gear and the planet gears may be adjusted by pivoting the sun gear by pivoting the motor held by the motor holder about the projections. Therefore, engagement between the sun gear and the planet gear may be adjusted by a simple component such as a motor holder having a plurality of projections. Therefore, the manufacturing cost maybe reduced.

When a plurality of pairs of projections are provided, each being disposed at two opposing locations with the intermediary of the centerline of the output shaft, the motor can be stabily pivoted by 360°. Thus, accuracy of adjustment of engagement between the sun gear and the planet gears may be improved.

In the embodiment described above, even when the motor holder has a projection that abuts against the entire periphery of the side surfaces of the end portion of the motor on the side opposite from the output shaft instead of the plurality of projections, the motor can be stabily pivoted by 360°. Therefore, accuracy of adjustment of engagement between the sun gear and the planet gear may be improved.

As illustrated, the motor holder is provided with a pair of side plates disposed on the side of the motor in parallel with the output shaft, a first end plate opposes the end surface of the motor on the output shaft side, and a second end plate opposes the end surface of the motor on the side opposite from the output shaft side. The side plates are provided with projections. The first end plate is divided into a first end plate strip integrated with a first side plate of the pair of side plates and a second end plate strip integrated with a second side plate of the pair of side plates. The second end plate includes a first hinge unit that rotatably supports the first side plate such that the first end plate strip moves away from the second end plate strip. A second hinge unit rotatably supports the second side plate such that the second end plate strip moves away from the first end plate strip. Each end plate strip has a notch that forms a hole thorough which the output shaft is arranged. The first side plate and the first end plate strip integral therewith may be opened and closed with respect to the second side plate and the second end plate strip integral therewith by rotating each of the side plates about the first hinge unit and the second hinge unit respectively. Therefore, the motor is disposed easily in the motor holder.

While particular embodiments of the present invention have been shown and described, modifications maybe made by one skilled in the art without altering the invention. It is therefore intended in the appended claims to cover such changes and modifications which follow in the true spirit and scope of the invention.

What is claimed is:

1. A manual input device comprising:
a rotatable operating member;
a motor that exerts a rotational force on the operating member, the motor having an output shaft;
a planet gear mechanism having a sun gear fixed to the output shaft of the motor, a plurality of planet gears engaging and moving around the sun gear, a ring gear engaging the planet gears on the inner peripheral side thereof, a carrier that rotatably supports the planet gears and rotates along with movement of the planet gears around the sun gear, and a carrier shaft that rotates integrally with the carrier and the operating member;
a detector that detects at least one of a direction of rotation and an amount of rotation of the output shaft of the motor;
a controller that controls the motor such that a predetermined rotational force is exerted on the operating member dependent on the at least one of the direction of rotation and the amount of rotation of the output shaft detected by the detector; and
a motor holder having at least one projection which abuts against at least one side surface of an end portion of the motor, the at least one projection disposed on a first side of the motor holder opposite from an output shaft side of the motor holder, the at least one projection configured to hold the motor.

2. The manual input device according to claim 1, wherein at least one pair of projections is provided such that each pair of projections are disposed at opposite locations with the intermediary of a centerline of the output shaft.

3. The manual input device according to claim 2, wherein a plurality of pairs of projections are provided.

4. The manual input device according to claim 1, wherein the motor holder has a single projection that abuts an entire periphery of the side surfaces of the end portion of the motor on the first side of the motor holder.

5. The manual input device according to claim 1, wherein the motor holder comprises:
a plurality of side plates disposed on a second side of the motor in parallel with the output shaft;
a first end plate opposing a first end surface of the motor on a side of the output shaft; and
a second end plate opposing a second end surface of the motor on a side opposite from the output shaft side,
wherein the side plates are provided with the at least one projection,
wherein the first end plate contains a first end plate strip integrated with a first side plate of the side plates and a second end plate strip integrated with a second side plate of the side plates,
wherein the second end plate includes a first hinge unit that rotatably supports the first side plate such that the first end plate strip is moveable away from the second end plate strip, and a second hinge unit that rotatably supports the second side plate such that the second end plate strip is moveable away from the first end plate strip, and
wherein each of the first and second end plate strip has a notch forming a hole thorough which the output shaft is arranged.

6. The manual input device according to claim 1, wherein the motor is pivotable by 360° about the at least one projection.

7. The manual input device according to claim 1, further comprising a limiting member to which the carrier is attached and that limits movement of the planet gears in an axial direction.

8. The manual input device according to claim 7, wherein:
the carrier has a disk portion and has connecting portions that extend along a periphery of the disk portion in the axial direction and that are connected to the limiting member, the connecting portions have projections projecting in the axial direction and snap claws projecting in a direction orthogonal to the axial direction, and
the limiting member has a disk portion and has connecting portions that extend along the periphery of the disk portion corresponding to the connecting portions of the carrier, the connecting portions of the limiting member have openings with which the snap claws engage, and the disk potion of the limiting member includes holes to which the projections of the connecting portions are fitted.

9. The manual input device according to claim 1, wherein the detector comprises:
an encoder having a code plate formed integrally with the sun gear;
a light emitting unit; and
a light receiving unit opposing the light emitting unit with the intermediary of the code plate.

10. The manual input device according to claim 9, further comprising:
a circuit board fixed to an end surface of the motor with a bracket, the light emitting unit and the light receiving unit connected to the circuit board; and
a holder fixed to the circuit board and holding the light emitting unit and the light receiving unit.

11. The manual input device according to claim 1, further comprising an annular member to which the motor holder is snap-fitted, the motor holder contacting an internal surface of the annular member, wherein snap claws provided on side plates of the motor holder engage with engaging holes formed on the annular member, and the ring gear is formed in the annular member.

12. A method of manufacturing a manual input device, the method comprising:
obtaining a rotatable operating member;
connecting a motor with the operating member such that the motor exerts a rotational force on the operating member;
attaching a sun gear to an output shaft of the motor;
coupling a plurality of planet gears with the sun gear such that the planet gears engage and move around the sun gear;
coupling a ring gear with the planet gears such that the planet gears engage an inner peripheral side of the ring gear;
rotatably supporting the planet gears with a carrier that rotates along with movement of the planet gears around the sun gear;
configuring a detector to detect at least one of a direction of rotation and an amount of rotation of the output shaft of the motor;
configuring a controller to control the motor such that a predetermined rotational force is exerted on the operating member dependent on the at least one of the direction of rotation and the amount of rotation of the output shaft detected by the detector; and
holding the motor using a motor holder having at least one projection that abuts against at least one side surface of an end portion of the motor, the at least one projection disposed on a first side of the motor holder opposite from an output shaft side of the motor holder, the at least one projection configured to hold the motor.

13. The method according to claim 12, further comprising providing at least one pair of projections such that each pair of projections are disposed at opposite locations with the intermediary of a centerline of the output shaft.

14. The manual input device according to claim 13, further comprising providing a plurality of pairs of projections.

15. The method according to claim 12, further comprising providing only a single projection that abuts an entire periphery of the side surfaces of the end portion of the motor on the first side of the motor holder.

16. The method according to claim 12, wherein the motor holder comprises a plurality of side plates disposed on a second side of the motor in parallel with the output shaft, a first end plate opposing a first end surface of the motor on a side of the output shaft, and a second end plate opposing a second end surface of the motor on a side opposite from the output shaft side,
wherein the side plates are provided with the at least one projection, the first end plate contains a first end plate strip integrated with a first side plate of the side plates and a second end plate strip integrated with a second side plate of the side plates, and
the method further comprises rotatably supporting the first side plate with a first hinge unit of the second end plate such that the first end plate strip is moveable away from the second end plate strip, rotatably supporting the second side plate with a second hinge unit such that the second end plate strip is moveable away from the first end plate strip, and arranging the output shaft through a notch in each of the first and second end plate strip.

17. The method according to claim 12, further comprising disposing the motor in the motor holder such that the motor is pivotable by 360° about the at least one projection.

18. The method according to claim 12, further comprising attaching a limiting member to the carrier thereby limiting movement of the planet gears in an axial direction.

19. The method according to claim 18, wherein:
the carrier has a disk portion and has connecting portions that extend along a periphery of the disk portion in the axial direction and that are connected to the limiting member, the connecting portions have projections projecting in the axial direction and snap claws projecting in a direction orthogonal to the axial direction,
the limiting member has a disk portion and has connecting portions that extend along the periphery of the disk portion corresponding to the connecting portions of the carrier, and
the method further comprises engaging the snap claws with openings of the connecting portions of the limiting member and fitting the projections of the connecting portions to holes in the disk potion of the limiting member.

20. The method according to claim 12, further comprising disposing a light emitting unit and a light receiving unit of the detector such that the light receiving unit opposes the light emitting unit with the intermediary of a code plate of an encoder, the code plate formed integrally with the sun gear.

21. The method according to claim 20, further comprising fixing a circuit board to an end surface of the motor with a bracket, the light emitting unit and the light receiving unit connected to the circuit board, a holder fixed to the circuit board and holding the light emitting unit and the light receiving unit.

22. The method according to claim 12, further comprising snap-fitting an annular member to the motor holder such that the motor holder contacts an internal surface of an annular member, the annular member being snap-fitted through engagement of snap claws provided on side plates of the motor holder with engaging holes formed on the annular member, the ring gear being formed in the annular member.

23. A manual input device comprising:
a rotatable operating member;
a motor that exerts a rotational force on the operating member, the motor having an output shaft;
a planet gear mechanism having a sun gear fixed to the output shaft of the motor, a plurality of planet gears engaging and moving around the sun gear, a ring gear engaging the planet gears on the inner peripheral side thereof, a carrier that rotatably supports the planet gears and rotates along with movement of the planet gears around the sun gear, and a carrier shaft that rotates integrally with the carrier and the operating member; and
a motor holder having at least one projection which abuts against at least one side surface of the motor and is configured to hold the motor such that the sun gear is pivotable with respect to the planet gear by pivoting the motor about the at least one projection of the motor holder.

24. The manual input device according to claim 23, wherein, engagement between the sun gear and the planet gears is adjustable solely through pivoting of the motor about the at least one projection of the motor holder.

25. The manual input device according to claim 23, wherein at least one pair of projections is provided such that each pair of projections are disposed at opposite locations with the intermediary of a centerline of the output shaft.

26. The manual input device according to claim 25, wherein a plurality of pairs of projections are provided.

27. The manual input device according to claim 23, wherein the motor holder has a single projection that abuts an entire periphery of the side surfaces of the motor.

28. The manual input device according to claim 23, wherein the motor is pivotable by 3600 about the at least one projection.

29. The manual input device according to claim 23, wherein the motor holder comprises:
a plurality of side plates disposed on a side of the motor in parallel with the output shaft;
a first end plate opposing a first end surface of the motor on a side of the output shaft; and
a second end plate opposing a second end surface of the motor on a side opposite from the output shaft side,
wherein the side plates are provided with the at least one projection,
wherein the first end plate contains a first end plate strip integrated with a first side plate of the side plates and a second end plate strip integrated with a second side plate of the side plates,
wherein the second end plate includes a first hinge unit that rotatably supports the first side plate such that the first end plate strip is moveable away from the second end plate strip, and a second hinge unit that rotatably supports the second side plate such that the second end plate strip is moveable away from the first end plate strip, and
wherein each of the first and second end plate strip has a notch forming a hole thorough which the output shaft is arranged.

30. The manual input device according to claim 23, further comprising a limiting member to which the carrier is attached and that limits movement of the planet gears in an axial direction.

31. The manual input device according to claim 30, wherein:
the carrier has a disk portion and has connecting portions that extend along a periphery of the disk portion in the axial direction and that are connected to the limiting member, the connecting portions have projections projecting in the axial direction and snap claws projecting in a direction orthogonal to the axial direction, and
the limiting member has a disk portion and has connecting portions that extend along the periphery of the disk portion corresponding to the connecting portions of the carrier, the connecting portions of the limiting member have openings with which the snap claws engage, and the disk potion of the limiting member includes holes to which the projections of the connecting portions are fitted.

32. The manual input device according to claim 23, further comprising an annular member to which the motor holder is snap-fitted, the motor holder contacting an internal surface of the annular member, wherein snap claws provided on side plates of the motor holder engage with engaging holes formed on the annular member, and the ring gear is formed in the annular member.
